(19) United States
(12) Patent Application Publication
(10) Pub. No.: US 2026/0302583 A1
(43) Pub. Date: Oct. 1, 2026

(54) SWITCHED CAPACITOR BANK UTILIZING OPEN-STUB TRANSMISSION LINES

(71) Applicant: Dell Products L.P., Round Rock, TX (US)

(72) Inventors: Tejinder Singh, Manotick (CA); Navjot Kaur Khaira, Manotick (CA)

(21) Appl. No.: 19/091,589

(22) Filed: Mar. 26, 2025

(51) Int. Cl. H01P 3/00

(52) U.S. Cl. CPC H01P 3/003

(57) ABSTRACT

The technology described herein is directed towards a tunable capacitor device in the form of a capacitor bank with switches that control the coupled or decoupled states of selectable open stub capacitors with respect to a transmission line, e.g., connected in a single-port coplanar waveguide configuration. By allowing any combination of N capacitors to be activated independently or simultaneously, the design enables two to the power N selectable states, where each state corresponds to a specific capacitance or combination of capacitances. In one example implementation, the capacitor bank includes six open stub capacitors and two multistate (single pole, three throw) RF switches. The multistate switches can include phase-change material-based junctions, whereby a controller can select the operating capacitance of the device by determining the conductive or non-conductive state of each switch junction by applying a set or reset pulse to a heating element associated with that junction.

### RELATED APPLICATION

The subject patent application is related to U.S. patent application Ser. No. ______ filed ______, entitled “PHASE SHIFTER TUNING USING DISCRETE SWITCHABLE OPEN STUBS” (docket no. 141961.01/DELLP1515US), the entirety of which patent application is hereby incorporated by reference herein.

### BACKGROUND

Capacitor banks in radio frequency (RF) hardware can be used for impedance matching, phase shifting, and frequency tuning in various telecom/radio systems. For example, capacitor banks have applications in C-Band RF hardware, including their use in radios, satellite communication systems, radar systems, 5G infrastructure systems, in filters, and in power amplifiers for improving signal performance.

### BRIEF DESCRIPTION OF THE DRAWINGS

The technology described herein is illustrated by way of example and not limited to the accompanying figures in which like reference numerals indicate similar elements and in which:

FIG. 1 is a top three-dimensional (3D) view representation of an example system including a model of a variable capacitive device with operational capacitance controlled by a controller, in accordance with various example embodiments and implementations of the subject disclosure.

FIG. 2 is a top 3D view representation of example capacitors of a capacitive device model, in accordance with various example embodiments and implementations of the subject disclosure.

FIG. 3 is a representation of a zoomed-in portion of FIG. 2 showing open stub capacitors of an example capacitive device model, in accordance with various example embodiments and implementations of the subject disclosure.

FIG. 4 is a top two-dimensional (2D) view of a scattering parameter (S-parameter) model of example capacitors of a capacitive device, in accordance with various example embodiments and implementations of the subject disclosure.

FIGS. 5 and 6 are circuit models used for simulation with respect to the example capacitive device, in accordance with various example embodiments and implementations of the subject disclosure.

FIG. 7 is a top 3D view representation showing an example junctions simulation model (with and without metal bridges), including a zoomed-in portion of one junction region, in accordance with various example embodiments and implementations of the subject disclosure.

FIG. 8A is a graphical representation of various S-parameters of the example junction model, with and without metal bridges, with respect to different frequencies, in accordance with various example embodiments and implementations of the subject disclosure.

FIG. 8B is a graphical representation of simulated return loss with respect to different frequencies for different states of the example capacitive device model, in accordance with various example embodiments and implementations of the subject disclosure.

FIG. 9 is a graphical representation of simulated insertion loss (including a portion thereof enlarged) with respect to different frequencies for different states of the example capacitive device model, in accordance with various example embodiments and implementations of the subject disclosure.

FIG. 10 is a graphical representation of simulated phase shift (including a portion thereof enlarged) with respect to different frequencies for different states of the example capacitive device model, in accordance with various example embodiments and implementations of the subject disclosure.

FIG. 11 is a graphical representation of simulated capacitance values (including a portion thereof enlarged) with respect to different frequencies for different states of the example capacitive device model, in accordance with various example embodiments and implementations of the subject disclosure.

FIGS. 12A, 12B and 12C are graphical representations of simulated return loss, insertion loss, and phase shift, respectively, of a first example “A” state of the example capacitive device model, in accordance with various example embodiments and implementations of the subject disclosure.

FIG. 12D is a legend identifying different ways in which the simulated values in the graphical representations of FIGS. 12A, 12B and 12C were obtained, in accordance with various example embodiments and implementations of the subject disclosure.

FIGS. 13A, 13B and 13C are graphical representations of simulated return loss, insertion loss, and phase shift, respectively, of a second example “B” state of the example capacitive device model, in accordance with various example embodiments and implementations of the subject disclosure.

FIG. 13D is a legend identifying different ways in which the simulated values in the graphical representations of FIGS. 13A, 13B and 13C were obtained, in accordance with various example embodiments and implementations of the subject disclosure.

FIGS. 14A, 14B and 14C are graphical representations of simulated return loss, insertion loss, and phase shift, respectively, of a third example “E” state of the example capacitive device model, in accordance with various example embodiments and implementations of the subject disclosure.

FIG. 14D is a legend identifying different ways in which the simulated values in the graphical representations of FIGS. 14A, 14B and 14C were obtained, in accordance with various example embodiments and implementations of the subject disclosure.

FIGS. 15A, 15B and 15C are graphical representations of simulated return loss, insertion loss, and phase shift, respectively, of a fourth example “I” state of the example capacitive device model, in accordance with various example embodiments and implementations of the subject disclosure.

FIG. 15D is a legend identifying different ways in which the simulated values in the graphical representations of FIGS. 15A, 15B and 15C were obtained, in accordance with various example embodiments and implementations of the subject disclosure.

FIG. 16 is a flow diagram showing example operations related to electrically coupling RF signals to selectable open stub capacitors of a device, in accordance with various aspects and implementations of the subject disclosure.

### DETAILED DESCRIPTION

Various implementations and embodiments of the technology described herein are generally directed towards a tunable capacitive radio frequency (RF) device that facilitates controlled selection of various capacitors of a capacitor bank, including in various combinations to obtain a specified operational capacitance of the device. Example usages of the tunable capacitive RF device include, but are not limited to, impedance matching and frequency-selective tuning.

In one implementation, described is an example capacitor bank utilizing two multistate RF switches (e.g., single-pole, three-throw (SP3T) switches) that enable the selection of multiple (e.g., six) distinct open stub capacitors connected to a co-coplanar waveguide (CPW) line. This configuration facilitates maintaining high flexibility and scalability while ensuring low insertion loss, e.g., across the C-band. By selectively activating a single or a combination of multiple states of the multistate RF switches, the tunable capacitive RF device provides a relatively large number of selectable operational states, allowing dynamic tuning of the capacitance for impedance matching or frequency adjustment. As a more particular example, for a tunable capacitive RF device with six open stub capacitors, any of 2⁶=64 operational states are available for controlled selection. Note that separating the six open stub capacitors into two capacitor subgroups, along with the use of two SP3T switches (one per subgroup), facilitate a compact device design (e.g., relative to six capacitors included or excluded via a single SP6T switch, although it is straightforward to implement such a design).

In one implementation, the switches include respective phase-change material junctions (e.g., Germanium telluride (GeTe)/chalcogenide material) that can be controlled into a conductive state or a nonconductive state based on heat applied via energy pulses to respective heating elements associated with the respective junctions. This allows coupling or decoupling any of the open stub capacitors to the RF transmission line, thereby resulting in a specified capacitance based on which capacitors are coupled, and which capacitors are decoupled.

The design of the tunable capacitive device facilitates a compact, cost-effective, and well-suited device for applications in tunable RF systems and adaptive filters. Note that while the example design described with respect to the example implementation is designed for C-band devices, the tunable capacitive device can be scaled as appropriate for other frequency bands.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some practical limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

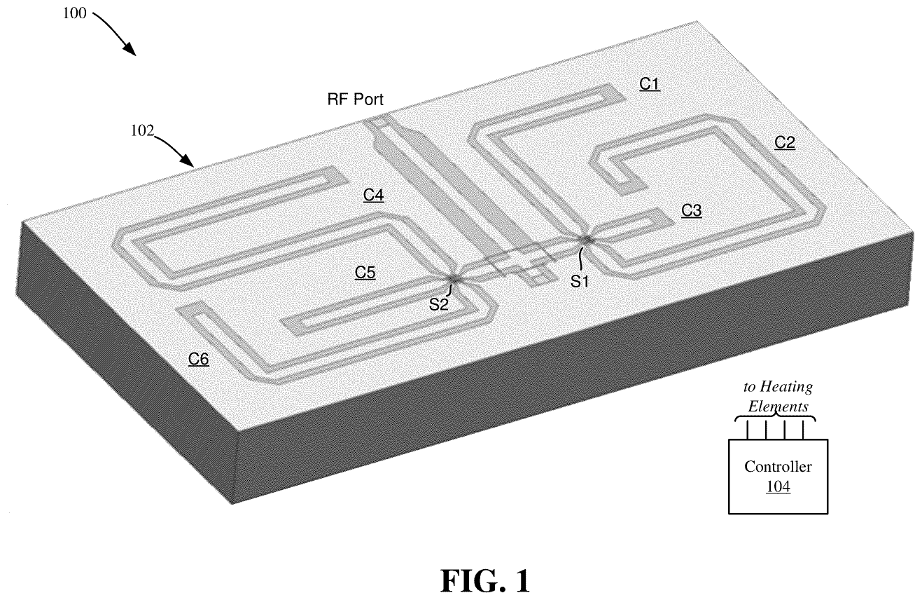

FIG. 1 is a block diagram showing an example system 100 including a tunable (variable) capacitive device 102 in which the operational capacitance of the tunable capacitive device 102 is controlled by a controller 104. In this example, the tunable capacitive device 102 includes six open stub capacitors C1-C6 and two multistate switches S1 and S2, which in this example are single pole, three throw RF switches; open stub capacitors use transmission line stubs to create capacitance. The states of the multistate switches S1 and S2 determine which open stub capacitors are coupled to the RF transmission line and thereby interact with RF signals thereon, or which are decoupled. As is seen in FIG. 1, the lengths of the six capacitors C1-C6 are each different from one another, and thereby have different capacitance values from one another. The following table, TABLE 1, shows capacitance values for six capacitors configured as the capacitor bank of FIG. 1 in one example implementation:

TABLE 1
Capacitors

C1 = 300 fF
C2 = 40 fF
C3 = 650 fF
C4 = 728 fF
C5 = 130 fF
C6 = 400 fF

Note that in general, capacitor banks are used for frequency control and tunability in various RF applications. Capacitor banks configurations for RF systems include series-parallel combinations and integrated designs, which helps to ensure wide tunability and compactness in telecommunications applications. Capacitor performance metrics include capacitance range, quality factor (Q-factor), self-resonant Frequency, power handling, and RF insertion loss define performance in high-frequency systems.

Typical capacitor banks are designed by integrating a multi-throw switch and either commercial off-the-shelf (COTS) capacitors or integrated metal-insulator-metal (MIM) capacitors. COTS are easy to implement, but the variation in performance is only useful for low-frequency applications. The MIM solution offers a high capacitance ratio per area, but usually has a poor Q-factor due to the large size of capacitors. Traditional designs, which often rely on fixed capacitor arrays or bulky mechanical tuners, are inherently limited in flexibility and scalability. Some modern solutions utilizing semiconductor switches have attempted to address these issues but still face significant challenges. These include limited configurability due to fixed-state designs, high insertion loss as the number of capacitors and switches increases, and complex control schemes that complicate the management of multiple switching states.

In contrast, the technology described herein facilitates a scalable, low-loss, and reconfigurable capacitor bank that offers a relatively large number of operational states while maintaining compactness and performance. In tunable RF systems, the technology described herein can achieve high configurability and compactness in capacitor banks, highly suitable for effective impedance matching and frequency-selective tuning, particularly in bands such as the C-band.

Turning to the multistate switches, in general, switches control the routing of RF signals in communication systems, and for example can be used for tasks like antenna selection and signal path switching. Common types of RF switches include PIN diodes, FET (field effect transistor)/GaN (Gallium Nitride) switches, and MEMS (micro-electromechanical systems) switches, each with different characteristics in terms of speed, power consumption, and performance. RF switches are used in devices such as mobile phones, base stations, and phased array antennas for tasks like signal routing, antenna switching, and phase shifting.

With phase change material switches useable in one or more implementations described herein, the controller selectively applies a set voltage or current pulse or a reset voltage or current pulse to each heating element to determine whether the phase change material junction associated with that heating element is in a conductive state or a nonconductive state, respectively. Notwithstanding, other types of switches can be used.

For the phase change material switches, chalcogenide material is formed with alloys containing group VI elements such as sulfur (S), selenium (Se) and telluride (Te). Among these, the alloys formed from different ratio combinations of germanium, antimony, and telluride (Ge—Sb—Te, or GST alloys) are currently the most popular for radio frequency and optical memory applications. In general, single-phase alloys are made of germanium telluride (GeTe) and antimony telluride (Sb2Te3). Alloys include Ge1Sb2Te4, Ge2Sb2Te5, and Ge1Sb4Te7. Depending on the alloy used, the properties range from high stability and low speed to low stability and high speed. The GST alloys have a unique property of reversibly switching between amorphous and crystalline states upon specific heat treatment by means of electrical pulses, hence the name “phase-change.” The state in which atoms are arranged in a disorderly manner (short range order) is called the amorphous state, whereas the state where atoms are organized in an orderly manner (long range order) is called crystalline state. The disordered amorphous state has a lower mean free path of conduction for electrons that impedes current flow due to electron scattering, thus resulting in a higher resistance when compared to the crystalline state.

In an implementation in which phase change material switches are employed, such as in FIG. 1, the operation principle of the example multistate switches S1 and S2 of 100 of FIG. 1 is based on the many orders of magnitude resistance change that chalcogenide phase change GST alloys undergo when provided a specific heat treatment using an energy pulse. Such materials can reversibly transition between a low resistance (metallic/conductive) state to a high resistance (insulator/resistive) state. This transition occurs due to the change in crystal structure of the alloy, which changes from amorphous to crystalline. In order to control the states of the material, a heater network has heating elements placed proximate to the phase change material (chalcogenide material) junctions. In general, a set pulse (to transition to the conductive state) has a relatively lower voltage than the reset pulse (to transition to the nonconductive state), with the set pulse applied for a longer time than the reset pulse. Significantly, once transitioned to the conductive state or the nonconductive state, the phase change material is latched in that state, meaning no power is needed to maintain that state, resulting in a low-power device that only needs energy if and when transitioning between states.

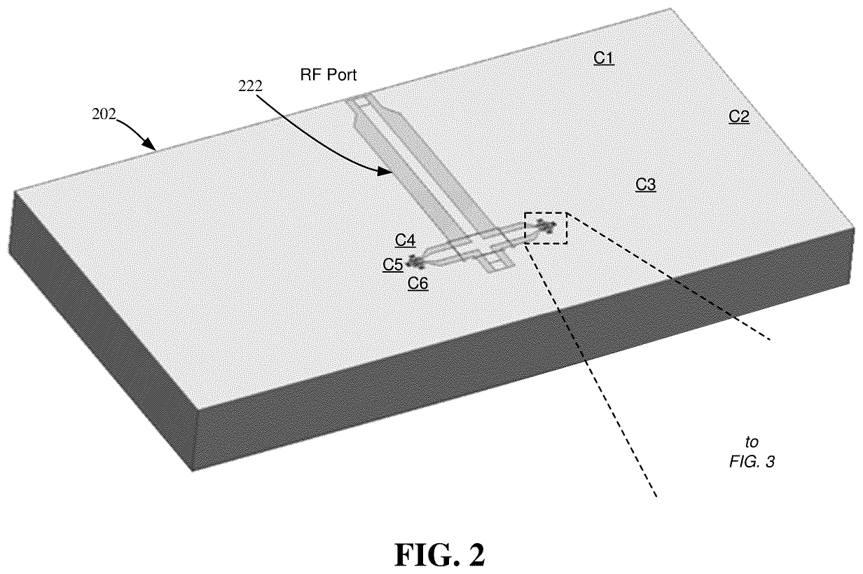

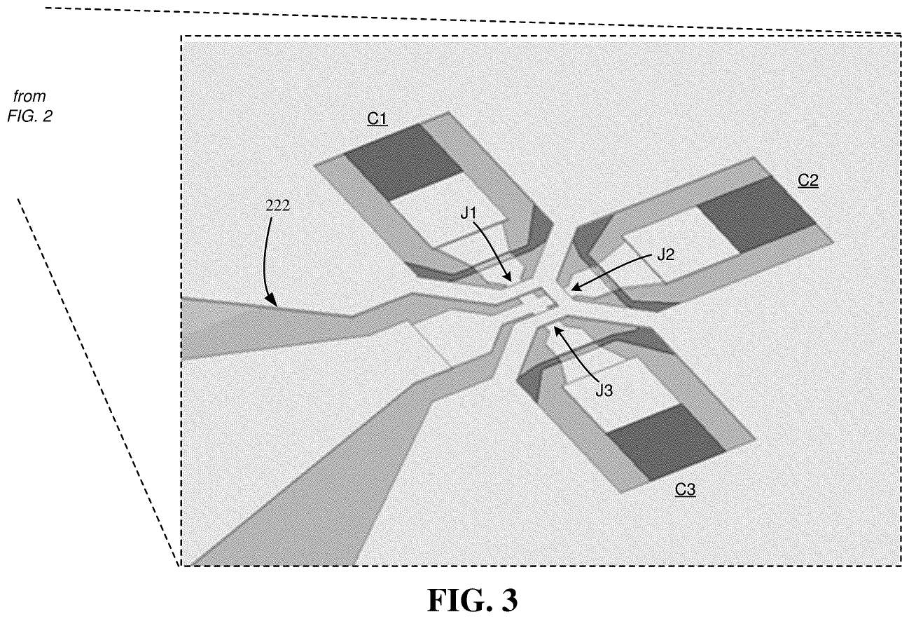

FIGS. 2 and 3 show a similar device 202 with a relatively longer split transmission line 222) (configured as a coplanar waveguide) compared to the area covered by the open stub capacitors C1-C6 in FIG. 1. FIG. 3 is a zoomed in portion of FIG. 2 showing the open stub capacitors C1-C3. Note that FIGS. 2 and 3 show the pole of the SP3T switch as being coupled to the transmission line, and phase change junctions J1-J3 that can be selectively controlled to be in conductive or nonconductive states, and thereby selectively couple the transmission line (single pole) to each capacitor, or decouple that capacitor.

To summarize, the tunable capacitive device 102 (FIG. 1) includes a capacitor bank having two SP3T switches to control six stubs (C1 to C6) connected in a single-port coplanar waveguide configuration, achieving high configurability without relying on grounded coplanar waveguide designs. By allowing any combination of the six capacitors to be activated independently, individually or simultaneously, the design enables 2⁶=64 states, where each state corresponds to a specific combination of capacitances.

Each stub is connected via an SP3T switch to the main CPW line, which allows selective capacitance loading. In this example switch configuration, each SP3T switch has three positions per side, enabling seamless control of capacitors. State control is obtained by independent control of switches (junctions), resulting in a total of 64 available states, offering high flexibility for impedance matching and frequency tuning. Notwithstanding, capacitor banks with more (or fewer) open stub capacitors and/or multistate switches can be configured in a similar way, resulting in more than 64 available states (for finer tuning) or less than 64 available states (for coarser tuning).

Some example states (nine possible states of the sixty-four available with the example implementation of FIG. 1) are shown in the following table, TABLE 2:

TABLE 2

| State | Capacitors |
|---|---|
| A | C1 |
| B | C2 |
| C | C4 |
| D | C5 |
| E | C1 + C4 |
| F | C3 + C5 |
| G | C3 + C6 |
| H | C1 + C2 + C3 |
| I | C1 + C2 + C3 + C4 + C5 + C6 |

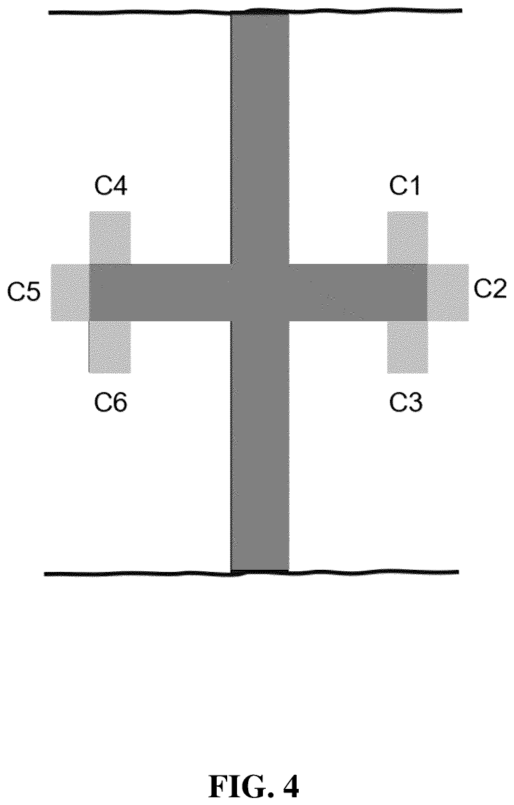

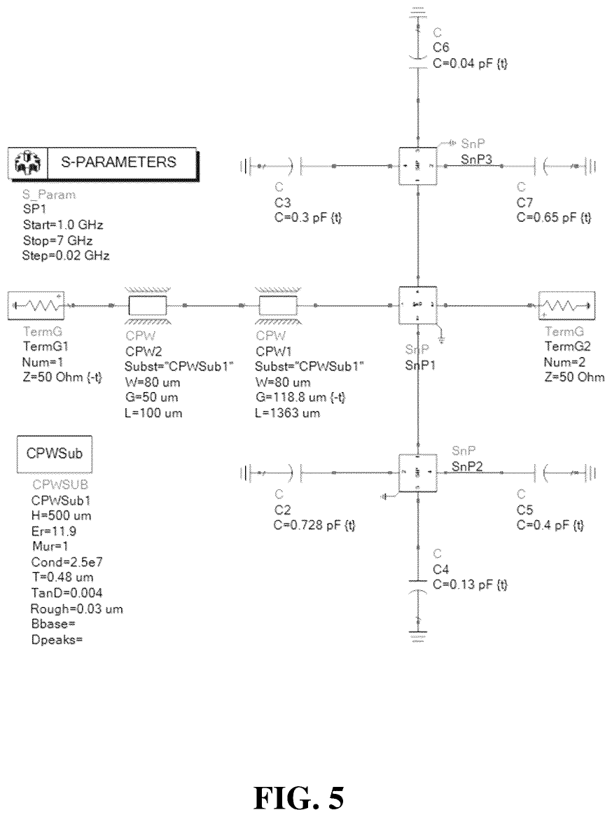

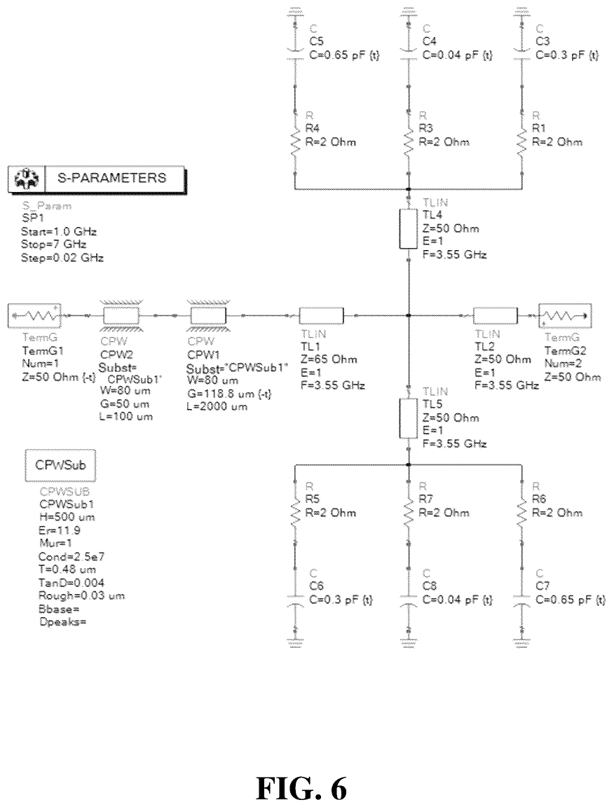

FIG. 4 is a top two-dimensional (2D) view of a scattering parameter (S-parameter) model of the example six capacitors of a capacitive device. FIGS. 5 and 6 are circuit models used for simulation with respect to the example capacitive device of FIG. 4. Note that for symmetry, the top portion of the capacitors can be copied and reflected in the bottom branch; (the actual C4, C5 and C6 values are correct in the simulation).

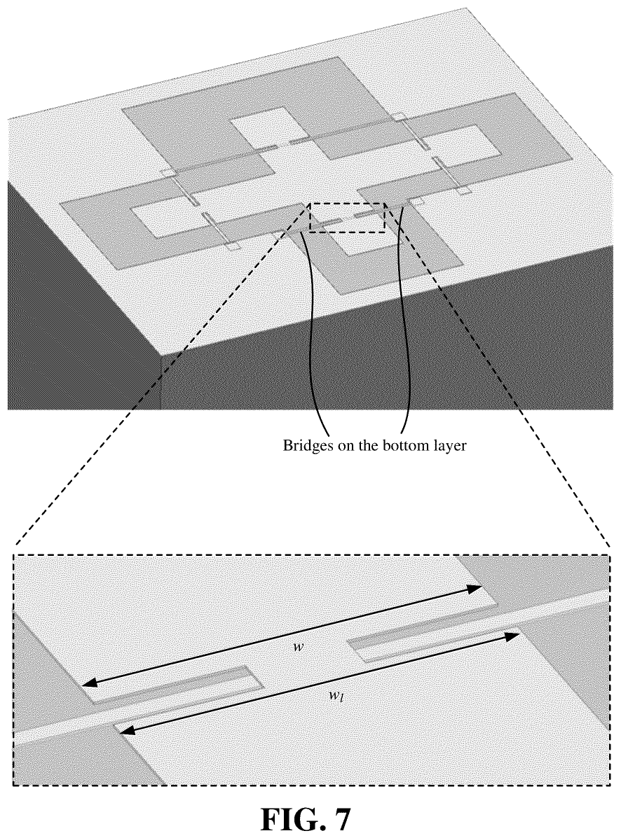

FIG. 7 is a top 3D view representation showing an example of junction simulations in a model (with and without metal bridges), e.g., Ansys HFSS (high-frequency structure simulator). FIG. 7 includes a zoomed-in portion of one junction region. The total length w is shown in the zoomed-in portion, along with the distance between them, wₗ. For simulation without bridges, wₗ is kept equal to w.

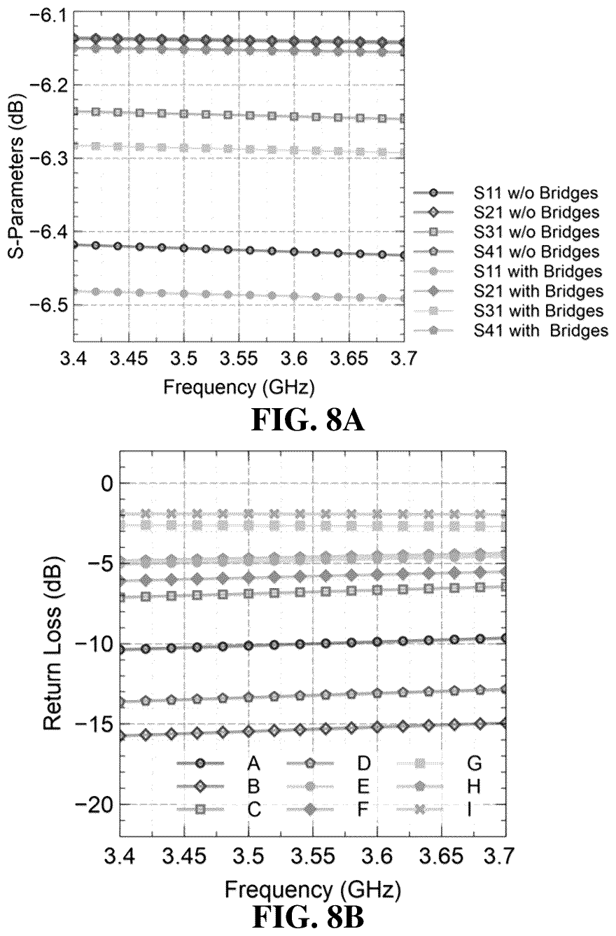

FIG. 8A is a graphical representation of the various S-parameters (S₁₁, S₂₁, S₃₁, S₄₁) of the example junction model of FIG. 7, with and without metal bridges, with respect to different frequencies ranging from 3.4 to 3.7 GHz. FIG. 8B is a graphical representation of simulated return loss with respect to the different frequencies for the different states (described in the example states of TABLE 2) of the example capacitive device model.

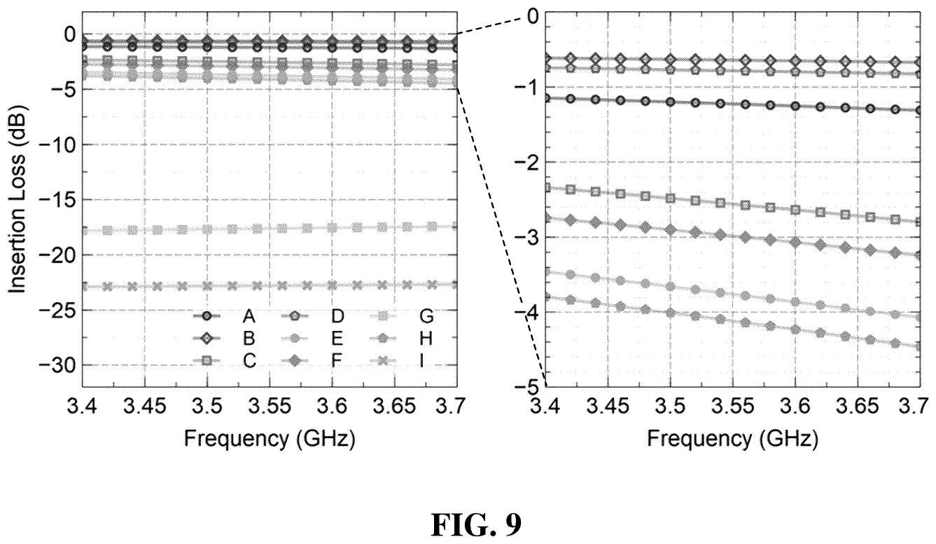

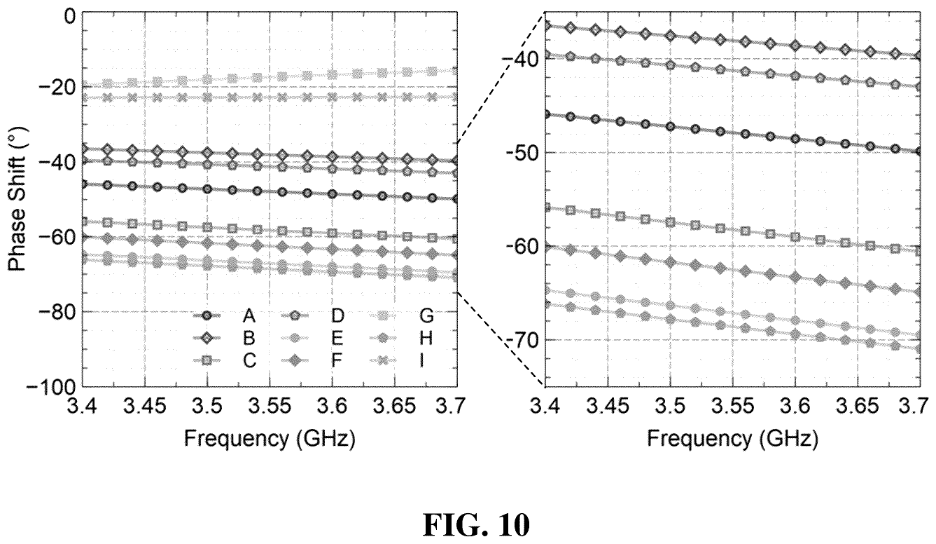

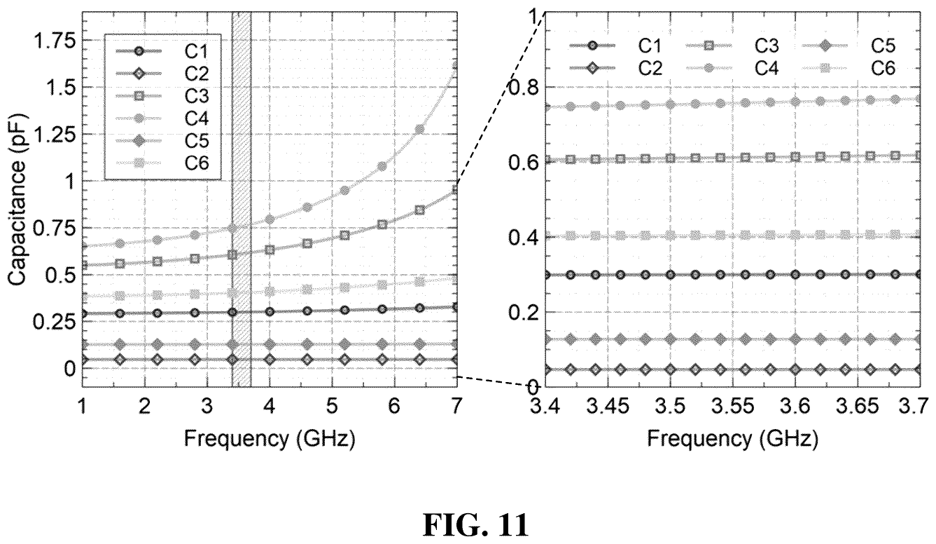

FIG. 9 is a graphical representation of simulated insertion loss in dB (including a portion thereof enlarged) with respect to the different frequencies (from 3.4 to 3.7 GHz) for the different example states of TABLE 2. FIG. 10 is a graphical representation of simulated phase shift in degrees (including a portion thereof enlarged) with respect to the different frequencies (from 3.4 to 3.7 GHz) for the different states of the example capacitive device model. FIG. 11 is a graphical representation of simulated capacitance values (including a portion thereof enlarged) with respect to the different frequencies for the different states of the example capacitive device model (with capacitors optimized in HFSS), in accordance with various example embodiments and implementations of the subject disclosure.

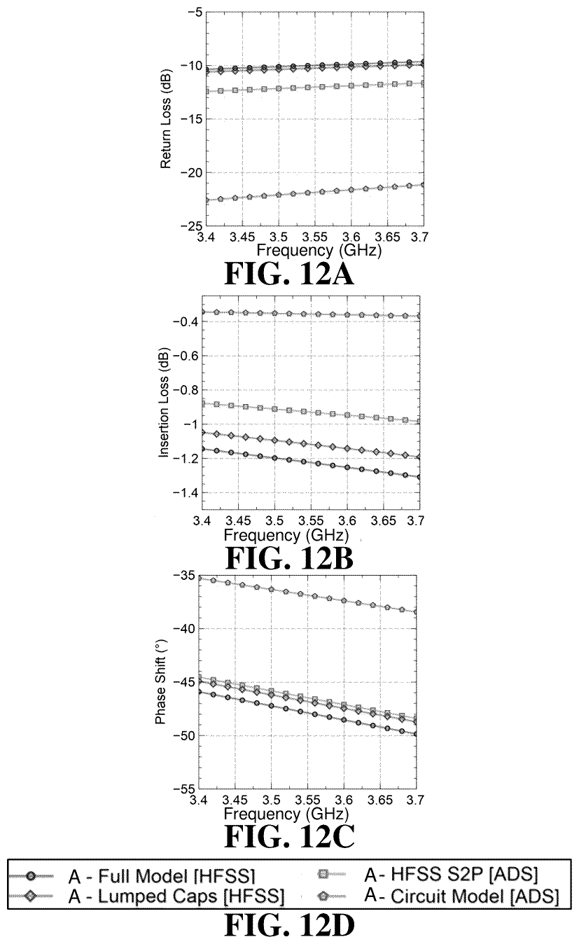

FIGS. 12A, 12B and 12C are graphical representations of simulated return loss in dB, insertion loss in dB, and phase shift in degrees, respectively, of the first example “A” state of the example capacitive device model. From the tables TABLE 1 and TABLE 2, state A represents the single selected capacitor C1=300 fF (femtofarads). FIG. 12D is a legend identifying different ways in which the simulated values in the graphical representations of FIGS. 12A, 12B and 12C for state A were obtained, namely via [HFSS] models and advanced design system (ADS) models.

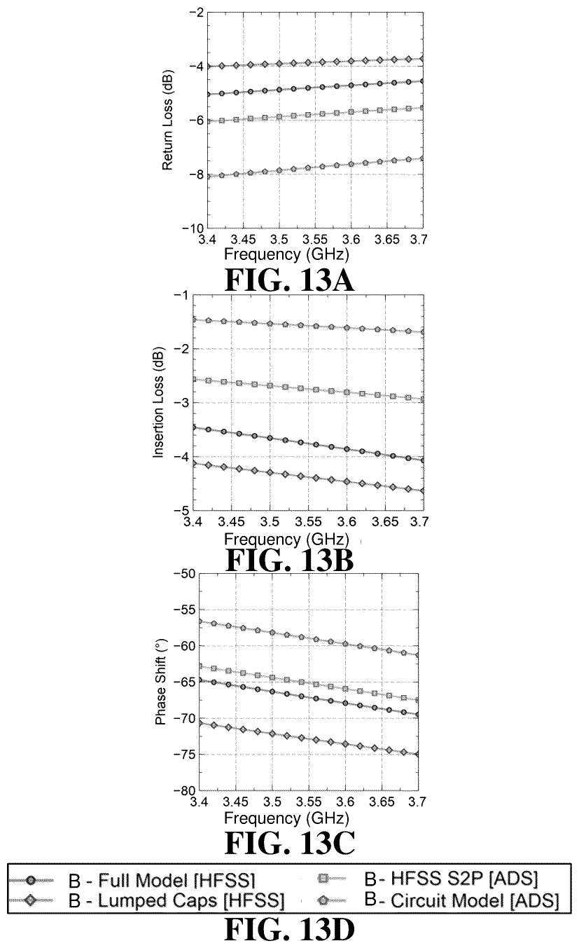

FIGS. 13A, 13B and 13C are graphical representations (similar to those of FIGS. 12A, 12B and 12C) of simulated return loss, insertion loss, and phase shift, respectively, of the second example “B” state of the example capacitive device model, using the various models. Note that state B is capacitor C2 alone, with a value of 40 fF.

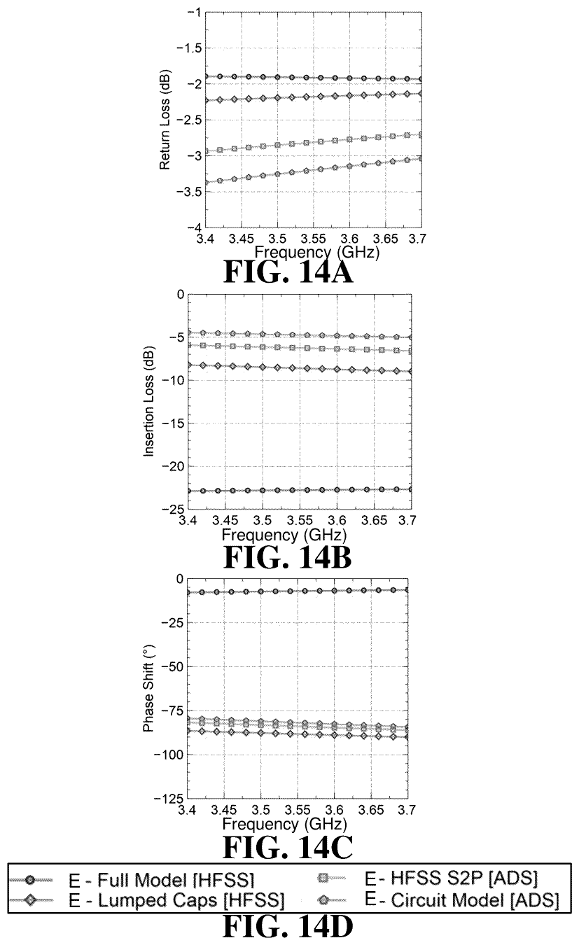

FIGS. 14A, 14B and 14C are graphical representations of simulated return loss, insertion loss, and phase shift, respectively, of the third example “E” state of the example capacitive device model. Note that state E is capacitors C1+C4, with values of 300 fF and 728 fF, respectively.

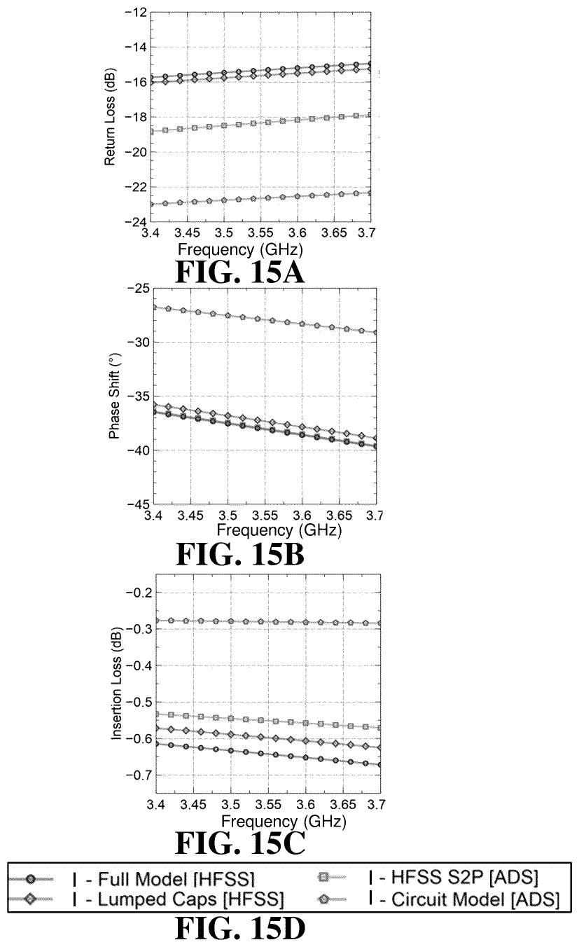

FIGS. 15A, 15B and 15C are graphical representations of simulated return loss, insertion loss, and phase shift, respectively, of the fourth example “I” state of the example capacitive device model. Note that state I is all of the capacitors switched to interact, that is, C1+C2+C3+C4+C5+C6, with values of C1=300 fF, C2=40 fF, C3=650 fF, C4=728 fF, C5=130 fF, and C6=400 fF, respectively.

One or more implementations can be embodied in a device, including a radio frequency (RF) port, an RF transmission line coupled to the RF port and a capacitor bank coupled to the RF transmission line. The capacitor bank can include a group of respective open stub capacitors coupled to respective RF switches. The respective RF switches are controllable to selectively couple the respective open stub capacitors of the group of respective open stub capacitors to the RF transmission line to determine an operational capacitance value of the device from among selective capacitance values that are based on respective capacitance values of the respective open stub capacitors, and based on which ones of the respective open stub capacitors are selectively coupled to the RF transmission line.

The RF transmission line can be configured as a co-coplanar waveguide line.

The respective open stub capacitors can include a first capacitor subgroup of the respective RF open stub capacitors, the respective RF switches can include a first switch subgroup of the respective RF switches coupled to the first capacitor subgroup, the respective open stub capacitors can include a second capacitor subgroup of the respective RF open stub capacitors, and the respective RF switches can include a second switch subgroup of the respective RF switches coupled to the second capacitor subgroup.

The first switch subgroup can be incorporated into a first multistate RF switch, and the second switch subgroup can be incorporated into a second multistate RF switch.

The first multistate RF switch can facilitate independent coupling of each open stub capacitor of the first capacitor subgroup to the RF transmission line.

The first capacitor subgroup can include a first open stub capacitor, a second open stub capacitor, and a third open stub capacitor, and the first multistate RF switch can include a single-pole, three-throw switch that facilitates independent coupling of the RF transmission line to at least one of: the first open stub capacitor, the second open stub capacitor, or the third open stub capacitor.

The single-pole, three-throw switch can be a first single-pole, three-throw switch, the second capacitor subgroup can include a fourth open stub capacitor, a fifth open stub capacitor, and a sixth open stub capacitor, and the second multistate RF switch can include a second single-pole, three-throw switch that facilitates independent coupling of the RF transmission line to at least one of: the fourth open stub capacitor, the fifth open stub capacitor, or the sixth open stub capacitor.

The respective RF switches can include respective phase change alloy material junctions.

The respective phase change alloy material junctions can be controllable to be in respective conductive or nonconductive states based on applying a set pulse to a first subgroup of respective heating elements associated with the respective phase change alloy material junctions to latch a first subgroup of the respective phase change alloy material junctions into respective conductive states, and applying a reset pulse to a second subgroup of the respective heating elements associated with the respective phase change alloy material junctions to latch a second subgroup of the respective phase change alloy material junctions into respective nonconductive states.

The respective phase change alloy material junctions can include germanium telluride.

The variable “N” can represent a number of the respective open stub capacitors in the capacitor bank, and the selective capacitance values can correspond to 2^{N}.

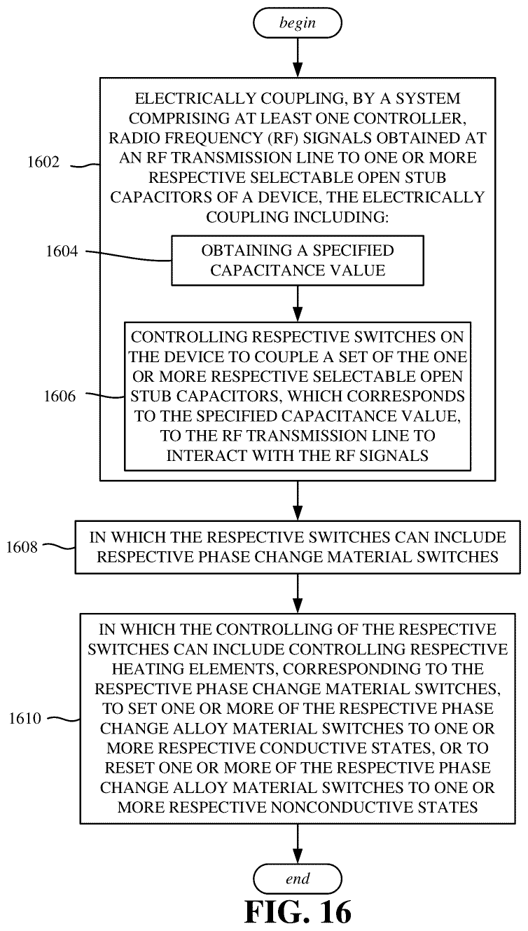

One or more example embodiments, implementations, and/or operations, such as corresponding to example operations of a method, can be represented in FIG. 16. Example operation 1602 represents electrically coupling, by a system comprising at least one controller, radio frequency (RF) signals obtained at an RF transmission line to one or more respective selectable open stub capacitors of a device, the electrically coupling can include example operations 1604 and 1606. Example operation 1604 represents obtaining a specified capacitance value. Example operation 1606 represents controlling respective switches on the device to couple a set of the one or more respective selectable open stub capacitors, which corresponds to the specified capacitance value, to the RF transmission line to interact with the RF signals. Example block 1608 represents that the respective switches can include respective phase change material switches. Example block 1610 represents the controlling the respective switches can include controlling respective heating elements, corresponding to the respective phase change material switches, to set one or more of the respective phase change alloy material switches to one or more respective conductive states, or to reset one or more of the respective phase change alloy material switches to one or more respective nonconductive states.

The respective phase change material switches can include respective phase change alloy switches, controlling the respective switches can include applying a set energy pulse to set a first subgroup of the one or more of the respective phase change alloy material switches to respective conductive states, and applying a reset energy pulse to set a second subgroup of the one or more of the respective phase change alloy material switches to respective nonconductive states.

The respective selectable open stub capacitors can include a first capacitor subgroup of the respective selectable open stub capacitors coupled to a first multistate switch associated with a first switch subgroup of the respective switches, and a second capacitor subgroup of the respective selectable open stub capacitors coupled to a second multistate switch associated with a second switch subgroup of the respective switches; controlling the respective switches can include controlling a first state of the first multistate switch, and controlling a second state of the second multistate switch.

The specified capacitance value can be a first specified capacitance value, the one or more respective conductive states can include a first subgroup of the one or more respective conductive states, the one or more respective nonconductive states can include a second subgroup of the one or more respective nonconductive states, and further operations can include obtaining, by the system, a second specified capacitance value, and changing, by the system, the first specified capacitance value to the second specified capacitance value, which can include controlling the respective switches to change the first subgroup of the one or more respective conductive states to a third subgroup of the one or more respective conductive states, and to change the second subgroup of the one or more respective nonconductive states to a fourth subgroup of the one or more respective nonconductive states, in which the third subgroup can be different from the first subgroup, and wherein the fourth subgroup can be different from the second subgroup.

One or more implementations can be embodied in a system including a controller, and a tunable capacitive device coupled to the controller. The tunable capacitive device can include a radio frequency (RF) port, an RF coplanar waveguide transmission line coupled to the RF port, and respective open stub capacitors configured to be coupled to the RF coplanar waveguide transmission line via respective RF switches. To determine an operating capacitance of the tunable capacitive device with respect to RF signals on the RF transmission line, the controller can control respective conductive or nonconductive states of the respective RF switches to respectively couple or decouple the respective open stub capacitors from the RF coplanar waveguide transmission line.

The respective RF switches can include respective phase change alloy junctions, the tunable capacitive device can include respective heating elements associated with the respective phase change alloy junctions, and the controller can control the respective conductive or nonconductive states of the respective RF switches by applying first energy to a first subgroup of the respective phase change alloy junctions to set the first subgroup of the phase change alloy junctions into conductive states, and by applying second energy to a second subgroup of the respective phase change alloy junctions to reset the second subgroup of the phase change alloy junctions into nonconductive states.

The respective open stub capacitors can include a first capacitor subgroup of the respective RF open stub capacitors, the respective RF switches can include a first switch subgroup of the respective RF switches coupled to the first capacitor subgroup, the respective open stub capacitors can include a second capacitor subgroup of the respective RF open stub capacitors, and the respective RF switches can include a second switch subgroup of the respective RF switches coupled to the second capacitor subgroup.

The first switch subgroup can be incorporated into a first multistate RF switch, and the second switch subgroup can be incorporated into a second multistate RF switch.

The first capacitor subgroup can include a first open stub capacitor, a second open stub capacitor, and a third open stub capacitor, the first multistate RF switch can include a first single-pole, multi-throw switch that facilitates independent coupling of the coplanar waveguide RF transmission line to at least one of: the first open stub capacitor, the second open stub capacitor, or the third open stub capacitor, the second capacitor subgroup can include a fourth open stub capacitor, a fifth open stub capacitor, and a sixth open stub capacitor, and the second multistate RF switch can include a second single-pole, multi-throw switch that facilitates independent coupling of the RF coplanar waveguide transmission line to at least one of: the fourth open stub capacitor, the fifth open stub capacitor, or the sixth open stub capacitor.

As can be seen, the technology described herein facilitates a tunable capacitor device in the form of a capacitor bank with switches that control open stub capacitors, e.g., connected in a single-port coplanar waveguide configuration. The capacitor bank achieves high configurability without relying on grounded coplanar waveguide designs. By allowing any combination of the N capacitors to be activated independently or simultaneously, the design enables 2^{N} selectable states, where each state corresponds to a specific capacitance or combination of capacitances.

In example implementations, the tunable capacitor device can be implemented in a monolithic design that offers relatively large number of configurable states, exceeding the flexibility of current designs. The tunable capacitor device can be implemented in a compact and scalable design by integrating stub-based capacitors into transmission lines controlled by multistate (e.g., multi-throw) switches. The design remains compact while enabling scalability for larger networks. Versatile capacitance loading is facilitated, in that each stub can be activated independently or in combination, enabling precise control over the equivalent capacitance value.

What has been described above include mere examples. It is, of course, not possible to describe every conceivable combination of components, materials or the like for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A device, comprising:
a radio frequency (RF) port;
an RF transmission line coupled to the RF port; and
a capacitor bank coupled to the RF transmission line, the capacitor bank comprising a group of respective open stub capacitors coupled to respective RF switches,
wherein the respective RF switches are controllable to selectively couple the respective open stub capacitors of the group of respective open stub capacitors to the RF transmission line to determine an operational capacitance value of the device from among selective capacitance values that are based on respective capacitance values of the respective open stub capacitors, and based on which ones of the respective open stub capacitors are selectively coupled to the RF transmission line.

2. The device of claim 1, wherein the RF transmission line is configured as a co-coplanar waveguide line.

3. The device of claim 1, wherein the respective open stub capacitors comprise a first capacitor subgroup of the respective RF open stub capacitors, wherein the respective RF switches comprise a first switch subgroup of the respective RF switches coupled to the first capacitor subgroup, wherein the respective open stub capacitors comprise a second capacitor subgroup of the respective RF open stub capacitors, and wherein the respective RF switches comprise a second switch subgroup of the respective RF switches coupled to the second capacitor subgroup.

4. The device of claim 3, wherein the first switch subgroup is incorporated into a first multistate RF switch, and wherein the second switch subgroup is incorporated into a second multistate RF switch.

5. The device of claim 4, wherein the first multistate RF switch facilitates independent coupling of each open stub capacitor of the first capacitor subgroup to the RF transmission line.

6. The device of claim 4, wherein the first capacitor subgroup comprises a first open stub capacitor, a second open stub capacitor, and a third open stub capacitor, and wherein the first multistate RF switch comprises a single-pole, three-throw switch that facilitates independent coupling of the RF transmission line to at least one of: the first open stub capacitor, the second open stub capacitor, or the third open stub capacitor.

7. The device of claim 6, wherein the single-pole, three-throw switch is a first single-pole, three-throw switch, wherein the second capacitor subgroup comprises a fourth open stub capacitor, a fifth open stub capacitor, and a sixth open stub capacitor, and wherein the second multistate RF switch comprises a second single-pole, three-throw switch that facilitates independent coupling of the RF transmission line to at least one of: the fourth open stub capacitor, the fifth open stub capacitor, or the sixth open stub capacitor.

8. The device of claim 1, wherein the respective RF switches comprise respective phase change alloy material junctions.

9. The device of claim 8, wherein the respective phase change alloy material junctions are controllable to be in respective conductive or nonconductive states based on:
applying a set pulse to a first subgroup of respective heating elements associated with the respective phase change alloy material junctions to latch a first subgroup of the respective phase change alloy material junctions into respective conductive states, and
applying a reset pulse to a second subgroup of the respective heating elements associated with the respective phase change alloy material junctions to latch a second subgroup of the respective phase change alloy material junctions into respective nonconductive states.

10. The device of claim 8, wherein the respective phase change alloy material junctions comprise germanium telluride.

11. The device of claim 1, wherein N represents a number of the respective open stub capacitors in the capacitor bank, and wherein the selective capacitance values correspond to 2^{N}.

12. A method, comprising:
electrically coupling, by a system comprising at least one controller, radio frequency (RF) signals obtained at an RF transmission line to one or more respective selectable open stub capacitors of a device, the electrically coupling comprising:
obtaining a specified capacitance value; and
controlling respective switches on the device to couple a set of the one or more respective selectable open stub capacitors, which corresponds to the specified capacitance value, to the RF transmission line to interact with the RF signals,
wherein the respective switches comprise respective phase change material switches, and
wherein the controlling of the respective switches comprises controlling respective heating elements, corresponding to the respective phase change material switches, to set one or more of the respective phase change alloy material switches to one or more respective conductive states, or to reset one or more of the respective phase change alloy material switches to one or more respective nonconductive states.

13. The method of claim 12, wherein the respective phase change material switches comprise respective phase change alloy switches, wherein the controlling of the respective switches comprises applying a set energy pulse to set a first subgroup of the one or more of the respective phase change alloy material switches to respective conductive states, and applying a reset energy pulse to set a second subgroup of the one or more of the respective phase change alloy material switches to respective nonconductive states.

14. The method of claim 12, wherein the respective selectable open stub capacitors comprise a first capacitor subgroup of the respective selectable open stub capacitors coupled to a first multistate switch associated with a first switch subgroup of the respective switches, and a second capacitor subgroup of the respective selectable open stub capacitors coupled to a second multistate switch associated with a second switch subgroup of the respective switches, and wherein the controlling of the respective switches comprises controlling a first state of the first multistate switch, and controlling a second state of the second multistate switch.

15. The method of claim 12, wherein the specified capacitance value is a first specified capacitance value, wherein the one or more respective conductive states comprise a first subgroup of the one or more respective conductive states, wherein the one or more respective nonconductive states comprise a second subgroup of the one or more respective nonconductive states, and further comprising:
obtaining, by the system, a second specified capacitance value; and
changing, by the system, the first specified capacitance value to the second specified capacitance value, the changing comprising:
controlling the respective switches to change the first subgroup of the one or more respective conductive states to a third subgroup of the one or more respective conductive states, and to change the second subgroup of the one or more respective nonconductive states to a fourth subgroup of the one or more respective nonconductive states,
wherein the third subgroup is different from the first subgroup, and wherein the fourth subgroup is different from the second subgroup.

16. A system, comprising:
a controller;
a tunable capacitive device coupled to the controller, the tunable capacitive device, comprising:
a radio frequency (RF) port;
an RF coplanar waveguide transmission line coupled to the RF port; and
respective open stub capacitors configured to be coupled to the RF coplanar waveguide transmission line via respective RF switches,
wherein, to determine an operating capacitance of the tunable capacitive device with respect to RF signals on the RF transmission line, the controller controls respective conductive or nonconductive states of the respective RF switches to respectively couple or decouple the respective open stub capacitors from the RF coplanar waveguide transmission line.

17. The system of claim 16, wherein the respective RF switches comprise respective phase change alloy junctions, wherein the tunable capacitive device comprises respective heating elements associated with the respective phase change alloy junctions, and wherein the controller controls the respective conductive or nonconductive states of the respective RF switches by applying first energy to a first subgroup of the respective phase change alloy junctions to set the first subgroup of the phase change alloy junctions into conductive states, and by applying second energy to a second subgroup of the respective phase change alloy junctions to reset the second subgroup of the phase change alloy junctions into nonconductive states.

18. The system of claim 16, wherein the respective open stub capacitors comprise a first capacitor subgroup of the respective RF open stub capacitors, wherein the respective RF switches comprise a first switch subgroup of the respective RF switches coupled to the first capacitor subgroup, wherein the respective open stub capacitors comprise a second capacitor subgroup of the respective RF open stub capacitors, and wherein the respective RF switches comprise a second switch subgroup of the respective RF switches coupled to the second capacitor subgroup.

19. The system of claim 18, wherein the first switch subgroup is incorporated into a first multistate RF switch, and wherein the second switch subgroup is incorporated into a second multistate RF switch.

20. The system of claim 19, wherein the first capacitor subgroup comprises a first open stub capacitor, a second open stub capacitor, and a third open stub capacitor, wherein the first multistate RF switch comprises a first single-pole, multi-throw switch that facilitates independent coupling of the coplanar waveguide RF transmission line to at least one of: the first open stub capacitor, the second open stub capacitor, or the third open stub capacitor, wherein the second capacitor subgroup comprises a fourth open stub capacitor, a fifth open stub capacitor, and a sixth open stub capacitor, and wherein the second multistate RF switch comprises a second single-pole, multi-throw switch that facilitates independent coupling of the RF coplanar waveguide transmission line to at least one of: the fourth open stub capacitor, the fifth open stub capacitor, or the sixth open stub capacitor.
